(19) United States
(12) Patent Application Publication
(10) Pub. No.: US 2021/0198518 A1
(43) Pub. Date: Jul. 1, 2021

(54) PRIMER COMPOSITION AND LAMINATED SUBSTRATE

(71) Applicant: INDUSTRIAL TECHNOLOGY RESEARCH INSTITUTE, Hsinchu (TW)

(72) Inventors: Jui-Hsiang TANG, Zhunan Township (TW); Chiu-Yen CHIU, Hsinchu City (TW)

(73) Assignee: INDUSTRIAL TECHNOLOGY RESEARCH INSTITUTE, Hsinchu (TW)

(21) Appl. No.: 16/919,619

(22) Filed: Jul. 2, 2020

(30) Foreign Application Priority Data
Dec. 31, 2019 (TW) 108148599

(51) Int. Cl. C09D 153/02; C09D 5/00; C09D 4/06; H01B 1/02

(52) U.S. Cl. CPC C09D 153/02; C09D 5/002; H01B 3/30; H01B 1/02; C09D 4/06

(57) ABSTRACT

A primer composition and a laminated substrate with a primer are provided. The primer composition includes 60 to 90 parts by weight of vinyl-aromatic-conjugated-diene copolymer, 1 to 16 parts by weight of a compound having at least three of terminal acryloyloxy groups and 5 to 24 parts by weight of a silane coupling agent, wherein the silane coupling agentis distinct from the compound having at least three of terminal acryloyloxy groups.

### CROSS REFERENCE TO RELATED APPLICATIONS

The application is based on, and claims priority of Taiwan Application Serial Number 108148599, filed on Dec. 31, 2019, the disclosure of which is hereby incorporated by reference herein in its entirety.

### TECHNICAL FIELD

The disclosure relates to a primer composition and a laminated substrate having a primer layer.

### BACKGROUND

As the demand from applications of high frequency high speed transmission grows, the required specification of PCB materials has also been constantly updated. In terms of substrate materials, the low transmission loss substrate is already commercially available. In order to apply on the applications of high frequency high speed transmission, the copper foils for a high frequency circuit have also been constantly improved.

In the field of printed circuit boards, a conventional copper foil is provided by forming a raw foil on the cathode wheel by electroplating, and then subjected to treatments to form a final product. The treatments include performing a roughening treatment on the rough surface of the raw foil to form a plurality of copper particles on the rough surface of the raw foil, thereby increasing the bonding strength between the copper foil and the substrate of the circuit board, that is, increasing the peel strength of the copper foil.

In recent years, the data processing speed and communication speed of electronic products have tended to develop toward high frequency and high speed. At present, most research reveal that the shape of the copper foil surface has a great influence on the transmission loss when transmitting high frequency signals. That is to say, copper foils with larger surface roughness have a longer signal propagation distance, which may cause signal attenuation or delay. On the other hand, as the frequency of transmission increases, the skin effect on the surface of the circuit becomes more pronounced. That is, the current in the conductor will be concentrated on the surface of the conductor, which leads to an increase of the resistance and delay of the signal as the area of the cross-section on which the current flows decreases.

Therefore, the industry is currently working on reducing the surface roughness of the copper foil to reduce transmission loss and meet the needs of high-frequency signal transmission. However, due to the limitations of the conventional process, it has been difficult to further reduce the surface roughness of the copper foil. In addition, although reducing the surface roughness of the copper foil can reduce the transmission loss of the high-frequency signal, the bonding strength between the copper foil and the circuit substrate would also be reduced, thereby causing the copper foil to peel off from the circuit substrate easily and decreasing the reliability of printed circuit boards.

### SUMMARY

According to embodiments of the disclosure, the disclosure provides a primer composition. The primer composition can include a vinyl-aromatic-conjugated-diene copolymer; a compound having at least three of terminal acryloyloxy groups; and, a silane coupling agent. The silane coupling agenti is distinct from the compound having at least three of terminal acryloyloxy groups. In the primer composition, the vinyl-aromatic-conjugated-diene copolymer can have 60 to 90 parts by weight, the compound having at least three of terminal acryloyloxy groups can have 1 to 16 parts by weight, and the silane coupling agent can have 5 to 24 parts by weight.

According to embodiments of the disclosure, the disclosure provides a laminated substrate. The laminated substrate includes a first conductive layer having a surface; a first primer layer disposed on the top surface of the first conductive layer; and, a dielectric layer disposed on the first primer layer. The first primer layer is a cured product of the primer composition of the disclosure.

A detailed description is given in the following embodiments with reference to the accompanying drawings.

### BRIEF DESCRIPTION OF THE DRAWINGS

FIG. 1 is a schematic diagram illustrating the laminated substrate according to an embodiment of the disclosure.

FIG. 2 is a schematic diagram illustrating the laminated substrate having two conductive layers according to an embodiment of the disclosure.

### DETAILED DESCRIPTION

The primer composition and laminated substrate of the disclosure is described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments.

Moreover, the use of ordinal terms such as “first”, “second”, “third”, etc., in the disclosure to modify an element does not by itself connote any priority, precedence, or order of one claim element over another or the temporal order in which it is formed, but are used merely as labels to distinguish one claim element having a certain name from another element having the same name (but for use of the ordinal term) to distinguish the claim elements.

As used herein, the term “about” in quantitative terms refers to plus or minus an amount that is general and reasonable to persons skilled in the art.

According to embodiments of the disclosure, due to the specific constituents and amount of the primer composition, the primer layer prepared from the primer composition exhibits high adhesive ability. The primer composition is used to form a primer layer, and a laminated substrate employing the primer layer can enhance the adhesion strength (i.e. high peeling strength) between a dielectric layer (such as resin prepreg) and a conductive layer (such as supper flat copper foil) without deteriorating the dielectric characteristic (such as dissipation factor (Df)) of the whole laminated substrate. According to embodiments of the disclosure, the primer composition of the disclosure is suitable for the preparation of the laminated substrate employing low roughness metal foil or ultra-low roughness metal foil. Accordingly, the laminated substrate of the disclosure exhibit high process yield, reliability and low manufacturing cost.

According to embodiments of the disclosure, the primer composition of the disclosure can include a vinyl-aromatic-conjugated-diene copolymer; a compound having at least three of terminal acryloyloxy groups (wherein the terminal acryloyloxy group includes terminal methacryloyloxy group); and, a silane coupling agent. Since the primer composition of the disclosure has a specific amount and ratio of vinyl-aromatic-conjugated-diene copolymer vinyl-aromatic-conjugated-diene copolymer, a compound having at least three of terminal acryloyloxy groups, and silane coupling agent, the primer layer prepared from the primer composition of the disclosure can have aforementioned advantages. As a result, the primer layer can meet the requirements of the laminated substrate (such as thin printed circuit board or high frequency high speed performance printed circuit board).

According to embodiments of the disclosure, the primer composition of the disclosure can include a vinyl-aromatic-conjugated-diene copolymer; a compound having at least three of functional groups (wherein the functional groups can be terminal acryloyloxy group or terminal methacryloyloxy group); and, a silane coupling agent. The silane coupling agenti is distinct from the compound having at least three of terminal acryloyloxy groups.

According to embodiments of the disclosure, the primer composition of the disclosure can include about 60 to 90 parts by weight (such as 63 to 90 parts by weight, 75 to 90 parts by weight, or 63 to 80 parts by weight) of vinyl-aromatic-conjugated-diene copolymer, about 1 to 16 parts by weight (such as 2 to 15.5 parts by weight, or 5 to 16 parts by weight) of a compound having at least three of terminal acryloyloxy group, and about 5 to 24 parts by weight (such as 7 to 24 parts by weight, or 13 to 24 parts by weight) of silane coupling agent. Due to the aforementioned specific constituents and amount, all constituents of the primer composition of the disclosure can be reacted to achieve an ideal condition. As a result, in the laminated substrate prepared from the primer composition of the disclosure, the adhesion strength between a dielectric layer and a conductive layer can be enhanced without deteriorating the dielectric characteristic of the laminated substrate.

According to embodiments of the disclosure, the total weight of the vinyl-aromatic-conjugated-diene copolymer, compound having at least three of terminal acryloyloxy groups, and silane coupling agent can be 100 parts by weight.

According to embodiments of the disclosure, the vinyl-aromatic-conjugated-diene copolymer is a copolymer prepared by copolymerizing a vinyl-aromatic monomer with a conjugated-diene monomer. The conjugated-diene monomer can be 1,3-butadiene, isoprene, 2,3-dimethyl-1,3-butadiene, 2-phenyl-1,3-butadiene, 1,3-pentadiene, 2-methyl-1,3-pentadiene, 1,3-hexadiene, 4,5-diethyl-1,3-octadiene, 3-butyl-1,3-octadiene, or a combination thereof; and, the vinyl-aromatic monomer can be styrene, methylstyrene, ethylstyrene, cyclohexylstyrene, vinyl biphenyl, 1-vinyl-5-hexyl naphthalene, vinyl naphthalene, vinyl anthracene, or a combination thereof.

According to embodiments of the disclosure, the vinyl-aromatic-conjugated-diene copolymer has a unit derived from the vinyl-aromatic monomer and a unit derived from the conjugated-diene monomer, wherein the ratio of the weight of units derived from the vinyl-aromatic monomer to the weight of units derived from the conjugated-diene monomer is about 16:84 to 80:20, such as about 20:80, 25:75, 28:72, 30:70, 32:68, 35:75, 40:60, 50:50, 60:40, 70:30, or 75:25.

According to embodiments of the disclosure, when the ratio of the weight of units derived from the vinyl-aromatic monomer to the weight of units derived from the conjugated-diene monomer is about 20:80 to 40:60, the adhesion strength between a dielectric layer and a conductive layer in the laminated substrate can be enhanced without deteriorating the dielectric characteristic of the laminated substrate.

According to embodiments of the disclosure, the vinyl-aromatic-conjugated-diene copolymer can be partially hydrogenated vinyl-aromatic-conjugated-diene copolymer or fully hydrogenated vinyl-aromatic-conjugated-diene copolymer.

According to embodiments of the disclosure, the vinyl-aromatic-conjugated-diene copolymer can be styrene-butadiene block copolymer (SB), styrene-butadiene-styrene block copolymer (SBS), styrene-isoprene block copolymer (SI), styrene-isoprene-styrene block copolymer (SIS), styrene-ethylene-butadiene-styrene block copolymer (SEBS), styrene-ethylene-propylene-styrene block copolymer (SEPS), or styrene-ethylene-butadiene block copolymer (SEB).

According to embodiments of the disclosure, the vinyl-aromatic-conjugated-diene copolymer can be modified or non-modified vinyl-aromatic-conjugated-diene copolymer. According to embodiments of the disclosure, the modified vinyl-aromatic-conjugated-diene copolymer can be vinyl-aromatic-conjugated-diene copolymer with a terminal functional group, wherein the terminal functional group can be amino group, alkylamino group, imino group, alkylimino group, or pyridyl group.

According to embodiments of the disclosure, the vinyl-aromatic-conjugated-diene copolymer can have a number average molecular weight between about 5,000 to 1,000,000, such as about 10,000 to 800,000, 10,000 to 500,000, 20,000 to 500,000, 20,000 to 200,000, or 30,000 to 100,000.

According to embodiments of the disclosure, the compound having at least three of terminal acryloyloxy groups can be a compound having three terminal acryloyloxy groups, a compound having four terminal acryloyloxy groups, a compound having five terminal acryloyloxy groups, or a compound having six terminal acryloyloxy groups. For example, the compound having at least three of terminal acryloyloxy groups can be pentaerythritol triacrylate, ethoxylated trimethylolpropane triacrylate, trimethylolpropane propoxylated triacrylate, trimethylolpropane trimethacrylate, pentaerythritol tetraacrylate, ethoxylated pentaerythritol tetraacrylate, ditrimethylolpropane tetraacrylate, propoxylated pentaerythritol tetraacrylate, dipentaerythritol hexaacrylate, ethoxylated trimethylol propane tri-methacrylate, propoxylated glycerol trimethacrylate, trimethylol propane trimethacrylate, tris(2-acryloyloxyethyl)isocyanurate, or a combination thereof.

According to embodiments of the disclosure, the compound having at least three of terminal acryloyloxy groups of the disclosure is distinct from the silane coupling agent.

According to embodiments of the disclosure, the silane coupling agent of the disclosure can be a silane compoound having at least one reactive functional group, wherein the reactive functional group can be selected from a group consisting of amino group, alkylamino, vinyl group, thiol group, phenyl group, acryloyl group, acryloyloxy group, allyl group, vinylbenzyl group, epoxypropyl group, propargyl group, cyanoallyl group and uramino group. According to embodiments of the disclosure, the silane coupling agent can be cyclosiloxane having at least one reactive functional group or polyhedral oligomeric silsesquioxane (POSS) having at least one reactive functional group.

According to embodiments of the disclosure, the silane coupling agent of the disclosure can be vinyltrichlorosilane, vinyltrimethoxysilane, vinyltriethoxysilane, 2-(3,4epoxycyclohexyl)ethyltrimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, N-2(-aminoethyl) 3-aminopropylmethyldimethoxysilane, N-2(-aminoethyl) 3-aminopropyltrimethoxysilane, N-2(aminoethyl) 3-aminopropyltriethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, N-(vinylbenzyl)-2-aminoethyl-3-aminopropyltrimethoxysilane hydrochloride, 3-ureidopropyltriethoxysilane, 3-chloropropyltrimethoxysilane, 3-mercaptopropylmethyldimethoxysilane, 3-mercaptopropyltrimethoxysilane, bis(triethoxysilylpropyl)tetrasulfide, 3-isocyanatepropyltriethoxysilane, vinyltris(2-methoxyethoxy)silane, vinylmethyldimethoxysilane, 3-mercaptopropyltriethoxysilane, 3-octanoylthio-1-propyltriethoxysilane, 3-isocyanatepropyltrimethoxysilane, 3-triethoxysilyl-N-(1,3-dimethyl-butylidene), 3-acryloxypropyltrimethoxysilane, N-(p-vinylbenzyl)-N-(trimethoxysilylpropyl)ethylenediamine hydrochloride, 3-glycidoxypropylmethyldimethoxysilane, bis[3-(triethoxysilyl)propyl]disulfide, vinyltriacetoxysilane, vinyltriisopropoxysilane, allyltrimethoxysilane, diallyldimethylsilane, 3-mercaptopropyltriethoxysilane, N-(1,3-dimethylbutylidene)-3-aminopropyltriethoxysilane, trimethyltriethenyl cyclotrisiloxane, tetramethyltetraethenyl cyclosiloxane, pentamethylpentaethenyl cyclopentasiloxane, or a combination thereof.

According to embodiments of the disclosure, the primer composition can further include an initiator, the initiator can be photo-initiator, thermal initiator, or a combination thereof. The initiator can have 1 to 10 parts by weight (such as 2 to 9 parts by weight, 5 to 10 parts by weight), and the total weight of the vinyl-aromatic-conjugated-diene copolymer, the compound having at least three of terminal acryloyloxy groups, and the silane coupling agent can be 100 parts by weight.

According to embodiments of the disclosure, the photo-initiator can be benzophenone, benzoin, 2-hydroxy-2-methyl-1-phenyl-propan-1-one, 2,2-dimethoxy-1,2-diphenylethan-1-one, 1-hydroxy cyclohexyl phenyl ketone, 2,4,6-trimethylbenzoyl diphenyl phosphine oxide, N-phenylglycine, 9-phenylacridine, benzyldimethylketal, bis(4-(diethylamino)phenyl)methanone, 2,4,5-triarylimidazole dimers, or a combination thereof.

According to embodiments of the disclosure, the initiator can be peroxide initiator, azo initiator, or persulfate initiator. According to embodiments of the disclosure, the peroxide initiator can be benzoyl peroxide, 1,1-bis(tert-butylperoxy)cyclohexane, 2,5-bis(tert-butylperoxy)-2,5-dimethylcyclohexane, 2,5-bis(tert-butylperoxy)-2,5-dimethyl-3-cyclohexyne, bis(1-(tert-butylpeorxy)-1-methy-ethyl)benzene, tert-butyl hydroperoxide, tert-butyl peroxide, tert-butyl peroxybenzoate, cumene hydroperoxide, cyclohexanone peroxide, dicumyl peroxide, lauroyl peroxide, or a combination thereof. According to embodiments of the disclosure, the azo initiator can be N,N′-azobisisobutyronitrile (AIBN), 2,2′-azobisisoheptonitrile (ABVN), 2,2′-azobis(2-methylbutyronitrile) (AMBN), 1,1′-Azobis(cyclohexane-1-carbonitrile) (ACCN), 1-((cyano-1-methylethyl)azo) formamide (CABN), 2,2′-azobis(2-methylpropionamide)dihydrochloride (AIBA), dimethyl 2,2′-azobis(2-methylpropionate) (AIBME), 2,2′-azobis[2-(2-imidazolin-2-yl)propane] dihydrochloride (AIBI), or a combination thereof. According to embodiments of the disclosure, the persulfate initiator can be sodium persulfate, potassium persulfate, ammonium persulfate, or a combination thereof.

According to embodiments of the disclosure, besides the initiator, the primer composition of the disclosure can optionally include other constituents (such as additives known by those skilled in the art) to improve the chemical or physical characteristics and processability of the laminated substrate employing the primer layer prepared from the primer composition. The additives known by those skilled in the art include, but not limited, flame retardant, viscosity modifier, thixotropic agent, defoamer, leveling agent, surface treatment agent, stabilizer, or antioxidant. The additive can be used alone or in combination. The amount of the additive is not limited and can be optionally modified by a person of ordinary skill in the field. For example, the additive can be about 0.1 to 50 parts by weight, and the total weight of the vinyl-aromatic-conjugated-diene copolymer, the compound having at least three of terminal acryloyloxy groups, and the silane coupling agent can be 100 parts by weight.

According to embodiments of the disclosure, the constituents of the primer composition of the disclosure, including vinyl-aromatic-conjugated-diene copolymer, the compound having at least three of terminal acryloyloxy groups, the silane coupling agent, and additives can be dissolved in a solvent, and used in a subsequent process.

The solvent here can be any inert solvent that can dissolve or disperse the constituents of the primer composition of the disclosure, but does not react with the constituents. For example, the solvent which can dissolve or disperse the constituents of the adhesive composition include but are not limited to benzene, toluene, xylene, hexane, cyclohexane, heptane, and decane. The listed solvents can be either used alone or in combination of two or more. The amount of the solvent is not particularly limited as long as the constituents of the primer composition can be evenly dissolved or dispersed therein. In the appended Examples, toluene is used as the solvent.

According to embodiments of the disclosure, the primer composition of the disclosure can consist of the vinyl-aromatic-conjugated-diene copolymer, the compound having at least three of terminal acryloyloxy groups, the silane coupling agent, and the solvent. According to embodiments of the disclosure, the primer composition of the disclosure can consist of the vinyl-aromatic-conjugated-diene copolymer, the compound having at least three of terminal acryloyloxy groups, the silane coupling agent, initiator and the solvent.

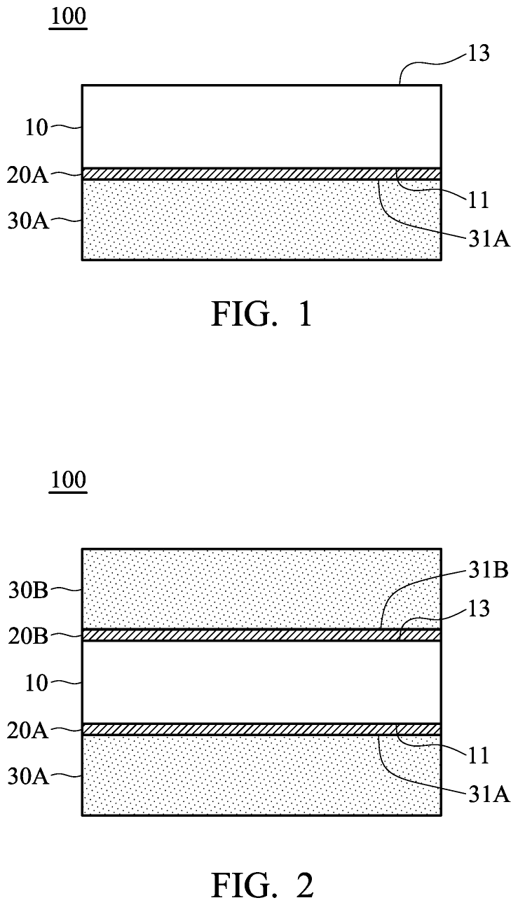

According to embodiments of the disclosure, the disclosure also provides a laminated substrate. FIG. 1 is a schematic diagram illustrating the laminated substrate 100 according to an embodiment of the disclosure.

As shown in FIG. 1, the laminated substrate 100 includes a dielectric layer 10 (including a bottom surface 11 and a top surface 13), a first conductive layer 30A disposed on the bottom surface 11, and a first primer layer 20A between the first conductive layer 30A and the dielectric layer 10 in order to fix the first conductive layer 30A on the dielectric layer 10. The first primer layer 20A is prepared from the primer composition. According to embodiments of the disclosure, the primer composition for preparing the primer layer is distinct from the composition for preparing the dielectric layer. According to embodiments of the disclosure, the surface 31A of the first conductive layer 30A contacts the first primer layer 20.

According to embodiments of the disclosure, the conductive layer (such as first conductive layer 30A) includes, but limited to, conductive metal foil. The conductive metal foil includes, but not limited to, copper foil, nickel foil or aluminum foil. According to embodiments of the disclosure, the conductive metal foil is copper foil. The thickness of the conductive layer thickness can be, but not limited to, from about 0.1 μm to 35 μm, such as from about 0.1 μm to 18 μm. The surface of the conductive metal foil can be smooth or roughened. In general, the high roughness of the conductive metal foil obstructs signal transmission. Therefore, the conductive metal foil preferably has low roughness. However, the low roughness of the conductive metal foil results in the poor adhesion strength between the conductive metal foil and the dielectric layer. As a result, the laminated substrate would exhibit a poor peeling strength, thereby reducing the reliability of the optoelectronic element employing the laminated substrate. The primer layer prepare from the primer composition of the disclosure can enhance the adhesion strength between the conductive metal foil (conductive layer) and the dielectric layer (such as first dielectric layer), thereby improving the peeling strength of the laminated substrate. According to embodiments of the disclosure, the surface of the conductive layer (such as the surface 31A of the first conductive layer 30A) can have an average surface roughness (i.e. ten-point average surface roughness (Rz)) less than or equal to about 2 μm, such as less than or equal to about 1.5 μm, or less than or equal to about 1μm. For example, the average surface roughness can be between 0.01 μm and 2 μm. According to embodiments of the disclosure, the ten-point average surface roughness (Rz) ism easured by a method in accordance with JIS B-0601 (1994) with a surfcorder (ET-3000).

According to embodiments of the disclosure, the method for preparing the laminated substrate 100 of FIG. 1 can include following steps. First, a first conductive layer 30A is provided. Next, the primer composition of the disclosure is coated on the surface 31A of the first conductive layer 30A to form a coating. Next, the coating is subjected to a baking or irradiation process to remove the solvent of the coating and cure the coating, thereby forming the first primer layer 20A. According to embodiments of the disclosure, the method for forming a coating of the primer composition can be screen printing, spin coating, bar coating, blade coating, roller coating, dip coating, spray coating, or brush coating. Next, the dielectric layer 10 is disposed on the first primer layer 20A (i.e. the bottom surface 11 of the dielectric layer 10 contacts the first primer layer 20A), forming a laminated structure (sequentially including the first conductive layer 30A, the first primer layer 20A, and the dielectric layer 10). Next, the laminated structure is subjected to a thermocompression, obtaining the laminated substrate 100. In addition, according to some embodiments of the disclosure, the first primer layer 20A can be prepared from the primer composition in the advance. Next, the first primer layer 20A and the dielectric layer 10 subsequently dispose on the first conductive layer 30A, and the result is subjected to the thermocompression.

According to embodiments of the disclosure, the surface 31A of the first conductive layer 30A contacts the first primer layer 20A. Due to the use of the primer composition of the disclosure, the adhesion strength of the dielectric layer (such as prepreg) and the conductive layer (such as supper flat copper foil) of the obtained laminated substrate can be enhanced without deteriorating the dielectric characteristic (such as dissipation factor (Df)) of the whole laminated substrate.

According to embodiments of the disclosure, the weight of the primer layer can be about 2 g/m2 to 18 g/m2, such as about 3 g/m2 to 10 g/m2. As a result, the adhesion strength between the conductive layer and the dielectric layer can be improved without deteriorating the dielectric characteristic of the laminated substrate. According to embodiments of the disclosure, the thickness of the primer layer can be about between 1 μm and 12 μm, such as 2 μm, 3 μm, 4 μm, 5 μm, 6 μm, 7 μm, 8 μm, 9 μm, 10 μm, or 11 μm. When the thickness of the primer layer is too thin, there is a poor adhesion strength between the dielectric layer and the conductive layer. In addition, when the thickness of the primer layer is thick, the laminated substrate exhibits poor dielectric characteristics and the adhesion strength between the dielectric layer and the conductive layer is poor.

According to embodiments of the disclosure, the method for preparing the dielectric layer includes coating a curable resin on a substrate. After drying, the dried film of the curable resin is removed from the substrate. The curable resin is not limited and can be optionally modified by a person of ordinary skill in the field. For example, the curable resin can be epoxy resin, phenol formaldehyde resin, hydrocarbon resin, acrylic acid resin, polyamide, polyimide, polymethyl methacrylate (PMMA), polyvinylpyrrolidone (PE), polystyrene, or polyvinylidene fluoride. The curable resin can be used alone or in combination. According to embodiments of the disclosure, the method for preparing the dielectric layer can include impregnating a reinforcing material in the curable resin or coating the curable resin on a reinforcing material, and drying the einforcing material.

According to embodiments of the disclosure, besides the first conductive layer, the laminated substrate of the disclosure can further include a second conductive layer disposed on the top surface of the dielectric layer. FIG. 2 is a schematic diagram illustrating the laminated substrate having two conductive layers according to an embodiment of the disclosure. As shown in FIG. 2, the laminated substrate 100 includes a dielectric layer 10 (having a bottom surface 11 and a top surface 13), a first conductive layer 30A disposed on the bottom surface 11, a first primer layer 20A disposed between the first conductive layer 30A and the dielectric layer 10, a second conductive layer 30B disposed on the top surface 13, a second primer layer 20B disposed between the second conductive layer 30B and the dielectric layer 10. The first conductive layer 30A is fixed with the dielectric layer 10 via the first primer layer 20A, and the second conductive layer 30B is fixed with the dielectric layer 10 via the second primer layer 20A.

According to embodiments of the disclosure, the first primer layer 20A and the second primer layer 20B can be the same or different. Namely, the primer composition for preparing the first primer layer 20A and the primer composition for preparing the second primer layer 20B can be the same or different. In addition, the first conductive layer 30A and the second conductive layer 30B can be the same or different.

Below, exemplary embodiments will be described in detail with reference to the accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

Primer Composition

### Preparation Example 1

77.8 parts by weight of styrene-ethylene-butadiene-styrene block copolymer (SEBS) (with a trade number of Tuftec P1500, commercially available from Asahi Kasei Corporation) (the weight ratio of styrene to ethylene-butadiene was 30:70) was dissolved in toluene, obtaining a first solution (with a solid content of 28 wt %). Next, 13.9 parts by weight of tris(2-acryloyloxyethyl)isocyanurate was dissolved in toluene, obtaining a second solution (the weight ratio of tris(2-acryloyloxyethyl)isocyanurate to toluene was 1:4). Next, the first solution was mixed with the second solution. Next, 8.3 parts by weight of 3-methacryloxypropyltrimethoxysilane (with a trade number of KBM-503, commercially available from Shin-Etsu Chemical Co., Ltd.) and 8.3 parts by weight of initiator (with a trade number of Luperox101, commercially available from Aldrich) were added into the mixture. After mixing uniformly and defoaming, Primer composition (1) was obtained.

### Preparation Example 2

Preparation Example 2 was performed in the same manner as in Preparation Example 1 except that the amount of styrene-ethylene-butadiene-styrene block copolymer was reduced from 77.8 parts by weight to 71.8 parts by weight, the amount of tris(2-acryloyloxyethyl)isocyanurate was reduced from 13.9 parts by weight to 12.8 parts by weight, the amount of 3-methacryloxypropyltrimethoxysilane was increased from 8.3 parts by weight to 15.4 parts by weight, and the amount of initiator was reduced from 8.3 parts by weight to 7.7 parts by weight, obtaining Primer composition (2).

### Preparation Example 3

Preparation Example 3 was performed in the same manner as in Preparation Example 1 except that the amount of styrene-ethylene-butadiene-styrene block copolymer was reduced from 77.8 parts by weight to 68.3 parts by weight, the amount of tris(2-acryloyloxyethyl)isocyanurate was increased from 13.9 parts by weight to 24.4 parts by weight, the amount of 3-methacryloxypropyltrimethoxysilane was reduced from 8.3 parts by weight to 7.3 parts by weight, and the amount of initiator 8.3 parts by weight to 7.3 parts by weight, obtaining Primer composition (3).

### Preparation Example 4

Preparation Example 4 was performed in the same manner as in Preparation Example 1 except that the amount of styrene-ethylene-butadiene-styrene block copolymer was reduced from 77.8 parts by weight to 63.7 parts by weight, the amount of tris(2-acryloyloxyethyl)isocyanurate was increased from 13.9 parts by weight to 22.7 parts by weight, the amount of 3-methacryloxypropyltrimethoxysilane was increased from 8.3 parts by weight to 13.6 parts by weight, and the amount of initiator was reduced from 8.3 parts by weight to 6.8 parts by weight, obtaining Primer composition (4).

### Comparative Preparation Example 1

90.3 parts by weight of styrene-ethylene-butadiene-styrene block copolymer (SEBS) (with a trade number of Tuftec P1500, commercially available from Asahi Kasei Corporation) (weight ratio of styrene to ethylene-butadiene was 30:70) was dissolved in toluene, obtaining a solution (with a solid content of 28 wt %). Next, 9.7 parts by weight of 3-methacryloxypropyltrimethoxysilane (with a trade number of KBM-503, commercially available from Shin-Etsu Chemical Co., Ltd.) and 9.7 parts by weight of initiator (with a trade number of Luperox101, commercially available from Aldrich) were added into the solution. After mixing uniformly and defoaming, Primer composition (5) was obtained.

### Comparative Preparation Example 2

84.8 parts by weight of styrene-ethylene-butadiene-styrene block copolymer (SEBS) (with a trade number of Tuftec P1500, commercially available from Asahi Kasei Corporation) (weight ratio of styrene to ethylene-butadiene was 30:70) was dissolved in toluene, obtaining a first solution (with a solid content of 28 wt %). Next, 15.2 parts by weight of tris(2-acryloyloxyethyl)isocyanurate was dissolved in toluene, obtaining a second solution (the weight ratio of tris(2-acryloyloxyethyl)isocyanurate to toluene was 1:4). Next, the first solution was mixed with the second solution. Next, 9.1 parts by weight of initiator (with a trade number of Luperox101, commercially available from Aldrich) were added into the mixture. After mixing uniformly and defoaming, Primer composition (6) was obtained.

### Preparation Example 5

Preparation Example 5 was performed in the same manner as in Preparation Example 1 except that styrene-ethylene-butadiene-styrene block copolymer (Tuftec P1500, weight ratio of styrene to ethylene-butadiene was 30:70) was replaced with styrene-ethylene-butadiene-styrene block copolymer (Tuftec N515, the weight ratio of styrene to ethylene-butadiene was 16:84), obtaining Primer composition (7).

### Preparation Example 6

Preparation Example 6 was performed in the same manner as in Preparation Example 1 except that styrene-ethylene-butadiene-styrene block copolymer (Tuftec P1500, the weight ratio of styrene to ethylene-butadiene was 30:70) was replaced with styrene-ethylene-butadiene-styrene block copolymer (Tuftec P5051, the weight ratio of styrene to ethylene-butadiene was 47:53), obtaining Primer composition (8).

### Preparation Example 7

Preparation Example 7 was performed in the same manner as in Preparation Example 1 except that the amount of styrene-ethylene-butadiene-styrene block copolymer (Tuftec P1500, weight ratio of styrene to ethylene-butadiene was 30:70) was replaced with styrene-ethylene-butadiene-styrene block copolymer (Asaflex A810, the weight ratio of styrene to ethylene-butadiene was 80:20), obtaining Primer composition (9).

### Preparation Example 8

Preparation Example 8 was performed in the same manner as in Preparation Example 1 except that 3-methacryloxypropyltrimethoxysilane (with a trade number of KBM-503, commercially available from Shin-Etsu Chemical Co., Ltd.) was replaced with N-2-(aminoethyl) 3-aminopropyltrimethoxysilane (with a trade number of KBM-603, commercially available from Shin-Etsu Chemical Co., Ltd.), obtaining Primer composition (10).

### Preparation Example 9

Preparation Example 9 was performed in the same manner as in Preparation Example 1 except that 3-methacryloxypropyltrimethoxysilane (with a trade number of KBM-503, commercially available from Shin-Etsu Chemical Co., Ltd.) was replaced with vinyltrimethoxysilane (with a trade number of KBM-1003, commercially available from Shin-Etsu Chemical Co., Ltd.), obtaining Primer composition (11).

### Examples 1-4

Primer compositions (1)-(4) were individually used to prepare Laminated substrates (1)-(4). First, the primer composition was coated on a copper foil (commercially available from Fukuda, with a trade number of T9DA) (with a thickness of about 18 μm, a surface average surface roughness (Rz) of about 0.5 μm) via a coating stick. After baking at 150° C. for 5 minutes to cure the composition, a primer layer (with a thickness of about 2.5 μm) was obtained. Next, a prepreg (with a trade number of RO-4450, commercially available from Rogers Co.) was disposed on the primer layer, obtaining a laminated structure. Next, the laminated structure was subjected to a thermocompression via a vacuum thermocompressor (at a temperature of 205° C. under a pressure of 15 kg/cm² for 2 hours), obtaining a laminated substrate. Next, the laminated substrate was subjected to a peeling strength test, and the result is shown in Table 1. The peeling strength test was performed by measuring the tear strength (90°) according IPC TM-650 2.4.8 via a tensile testing machine (with a trade number of HT-9102).

### Comparative Examples 1 and 2

Primer compositions (5) and (6) were individually used to prepare Laminated substrates (5) and (6). First, the primer composition was coated on a copper foil (commercially available from Fukuda, with a trade number of T9DA) (with a thickness of about 18 μm, a surface average surface roughness (Rz) of about 0.5 μm) via a coating stick. After baking at 150° C. for 5 minutes to cure the composition, a primer layer (with a thickness of about 2.5 μm) was obtained. Next, a prepreg (with a trade number of RO-4450, commercially available from Rogers Co.) was disposed on the primer layer, obtaining a laminated structure. Next, the laminated structure was subjected to a thermocompression via a vacuum thermocompressor (at a temperature of 205° C. under a pressure of 15 kg/cm² for 2 hours), obtaining a laminated substrate. Next, the laminated substrate was subjected to a peeling strength test, and the result is shown in Table 1.

### Comparative Example 3

A prepreg (with a trade number of RO-4450, commercially available from Rogers Co.) disposed on a copper foil (commercially available from Fukuda, with a trade number of T9DA) (with a thickness of about 18 μm, a surface average surface roughness (Rz) of about 0.5 μm), obtaining a laminated structure. Next, the laminated structure was subjected to a thermocompression via a vacuum thermocompressor (at a temperature of 205° C. under a pressure of 15 kg/cm² for 2 hours), obtaining Laminated substrate (7). Next, Laminated substrate (7) was subjected to a peeling strength test, and the result is shown in Table 1.

TABLE 1
RO-4450 (from Rogers Co.) as prepreg

| | SEBS | tris(2-acryloyloxy- | KBM-503 | peeling |
|---|---|---|---|---|
| | (parts by | ethyl)isocyanurate | (parts by | strength |
| | weight) | (parts by weight) | weight) | (kg/cm) |
| Example 1 - | 77.8 | 13.9 | 8.3 | 0.48 |
| Laminated | | | | |
| substrate (1) | | | | |
| Example 2 - | 71.8 | 12.8 | 15.4 | 0.43 |
| Laminated | | | | |
| substrate (2) | | | | |
| Example 3 - | 68.3 | 24.4 | 7.3 | 0.52 |
| Laminated | | | | |
| substrate (3) | | | | |
| Example 4 - | 63.7 | 22.7 | 13.6 | 0.51 |
| Laminated | | | | |
| substrate (4) | | | | |
| Comparative | 90.3 | 0 | 9.7 | 0.35 |
| Example 1- | | | | |
| Laminated | | | | |
| substrate (5) | | | | |
| Comparative | 84.8 | 15.2 | 0 | 0.37 |
| Example 2- | | | | |
| Laminated | | | | |
| substrate (6) | | | | |
| Comparative | 0 | 0 | 0 | <0.1 |
| Example 3- | | | | |
| Laminated | | | | |
| substrate (7) | | | | |

### Example 5

The primer composition (1) was coated on a copper foil a copper foil (commercially available from Fukuda, with a trade number of T9DA) (with a thickness of about 18 μm, a surface average surface roughness (Rz) of about 0.5 am) via a coating stick. After baking at 150° C. for S5 minutes to cure the composition, a primer layer (with a thickness of about 2.5 am) was obtained. Next, a prepreg (with a trade number of R-5680 (MEGTRON7 series), commercially available from Panasonic) was disposed on the primer layer, obtaining a laminated structure. Next, the laminated structure was subjected to a thermocompression via a vacuum thermocompressor (at a temperature of 205° C. under a pressure of 15 kg/cm² for 2 hours), obtaining a laminated substrate (8). Next, Laminated substrate (8) was subjected to a peeling strength test, and the result is shown in Table 2.

### Comparative Examples 4 and 5

Primer compositions (5) and (6) were individually used to prepare Laminated substrates (9) and (10). First, the primer composition was coated on a copper foil (commercially available from Fukuda, with a trade number of T9DA) (with a thickness of about 18 μm, a surface average surface roughness (Rz) of about 0.5 μm) via a coating stick. After 150° C. for 5 minutes to cure the composition, a primer layer (with a thickness of about 2.5 μm) was obtained. Next, a prepreg (with a trade number of R-5680 (MEGTRON7 series), commercially available from Panasonic) was disposed on the primer layer, obtaining a laminated structure. Next, the laminated structure was subjected to a thermocompression via a vacuum thermocompressor (at a temperature of 205° C. under a pressure of 15 kg/cm² for 2 hours), obtaining a laminated substrate. Next, the laminated substrate was subjected to a peeling strength test, and the result is shown in Table 2.

### Comparative Example 6

A prepreg (with a trade number of R-5680 (MEGTRON7 series), commercially available from Panasonic) was disposed on a copper foil (commercially available from Fukuda, with a trade number of T9DA) (with a thickness of about 18 μm, a surface average surface roughness (Rz) of about 0.5 μm), obtaining a laminated structure. Next, the laminated structure was subjected to a thermocompression via a vacuum thermocompressor (at a temperature of 205° C. under a pressure of 15 kg/cm² for 2 hours), obtaining a laminated substrate (11). Next, laminated substrate (11) was subjected to a peeling strength test, and the result is shown in Table 2.

TABLE 2
5680 (MEGTRON7 series) from Panasonic as prepreg

| | SEBS | tris(2-acryloyloxy- | KBM-503 | peeling |
|---|---|---|---|---|
| | (parts by | ethyl)isocyanurate | (parts by | strength |
| | weight) | (parts by weight) | weight) | (kg/cm) |
| Example 5 - | 77.8 | 13.9 | 8.3 | 0.8 |
| Laminated | | | | |
| substrate (8) | | | | |
| Comparative | 90.3 | 0 | 9.7 | 0.65 |
| Example 4- | | | | |
| Laminated | | | | |
| substrate (9) | | | | |
| Comparative | 84.8 | 15.2 | 0 | 0.7 |
| Example 5- | | | | |
| Laminated | | | | |
| substrate (10) | | | | |
| Comparative | 0 | 0 | 0 | 0.4 |
| Example 6- | | | | |
| Laminated | | | | |
| substrate (11) | | | | |

As shown in Tables 1 and 2, in comparison with Comparative Examples 1-6 (i.e. the primer composition did not simultaneously include vinyl-aromatic-conjugated-diene copolymer, the compound having at least three of terminal acryloyloxy groups, and/or silane coupling agent), the laminated substrates (Examples 1-5) including the primer layer preparing from the primer composition of the disclosure exhibit improved adhesion strength between the copper foil and prepreg.

### Example 6

Primer composition (1) was coated on a copper foil (commercially available from Fukuda, with a trade number of T9DA) (with a thickness of about 18 μm, a surface average surface roughness (Rz) of about 0.5 μm) via a coating stick. After 150° C. for 5 minutes to cure the composition, a primer layer (with a thickness of about 4 μm) was obtained. Next, a prepreg (with a trade number of RO-4450, commercially available from Rogers Co.) was disposed on the primer layer, obtaining a laminated structure. Next, the laminated structure was subjected to a thermocompression via a vacuum thermocompressor (at a temperature of 205° C. under a pressure of 15 kg/cm² for 2 hours), obtaining Laminated substrate (12). Next, Laminated substrate (12) was subjected to a peeling strength test, and the result is shown in Table 3.

### Examples 7-9

Examples 7-9 were performed in the same manner as in Example 6, except that the thickness of the primer layer was increased from 4 μm to 5 μm, 6 μm, and 11 μm respectively, obtaining Laminated substrates (13)-(15). Next, the laminated substrate was subjected to a peeling strength test, and the result is shown in Table 3.

### Example 10

Primer composition (1) was coated on a copper foil (commercially available from Fukuda, with a trade number of T9DA) (with a thickness of about 18 μm, a surface average surface roughness (Rz) of about 0.5 μm) via a coating stick. After 150° C. for 5 minutes to cure the composition, a primer layer (with a thickness of about 4 μm) was obtained. Next, a prepreg (with a trade number of R-5680 (MEGTRON7 series), commercially available from Panasonic) was disposed on the primer layer, obtaining a laminated structure. Next, the laminated structure was subjected to a thermocompression via a vacuum thermocompressor (at a temperature of 205° C. under a pressure of 15 kg/cm² for 2 hours), obtaining Laminated substrate (16). Next, Laminated substrate (16) was subjected to a peeling strength test, and the result is shown in Table 3.

### Examples 11-13

Examples 11-13 were performed in the same manner as in Example 10, except that the thickness of the primer layer was increased from 4 μm to 5 μm, 6 μm, and 11 μm respectively, obtaining Laminated substrates (17)-(19). Next, the laminated substrate was subjected to a peeling strength test, and the result is shown in Table 3.

TABLE 3

| | thick- | peeling | | thick- | peeling |
|---|---|---|---|---|---|
| | ness | strength | | ness | strength |
| | (μm) | (kg/cm) | | (μm) | (kg/cm) |
| Example 1 - | 2.5 | 0.48 | Example 5 - | 2.5 | 0.8 |
| Laminated | | | Laminated | | |
| substrate (1) | | | substrate (8) | | |
| Example 6 - | 4 | 0.67 | Example 1 0- | 4 | 0.9 |
| Laminated | | | Laminated | | |
| substrate (12) | | | substrate (16) | | |
| Example 7 - | 5 | 0.72 | Example 11 - | 5 | 0.95 |
| Laminated | | | Laminated | | |
| substrate (13) | | | substrate (17) | | |
| Example 8 - | 6 | 0.75 | Example 12 - | 6 | 1.02 |
| Laminated | | | Laminated | | |
| substrate (14) | | | substrate (18) | | |
| Example 9 - | 11 | 0.6 | Example 13 - | 11 | 0.8 |
| Laminated | | | Laminated | | |
| substrate (15) | | | substrate (19) | | |

As shown in Table 3, the adhesion strength between the copper foil and the prepreg can be improved by adjusting the thickness of the primer layer prepared from the primer composition of the disclosure.

Next, the dielectric constant (Dk) and dielectric dissipation factor (Df) of Laminated substrates (7), (11), and (14)-(18) were measured, and th results are shown in Table 4. The dielectric constant (Dk) was measured at a frequency of 10 GHz or 10 30 GHz using a microwave dielectrometer (available from AET Corporation). The dielectric dissipation factor (Df) was measured by a split-post dielectric resonator (SPDR) vailable from Genie Networks). Specifically, the materials having low dielectric dissipation factor under high-frequency conditions (quartz) were used to form a resonance structure. The sample was placed between the two materials so that the resonance signal (at a frequency of 10 GHz or 10 30 GHz) was interfered with, and the dielectric properties of the sample were obtained by inversion calculation.

TABLE 4

| | 10 GHz | | 30 GHz | |
|---|---|---|---|---|
| | dielectric | dielectric | dielectric | dielectric |
| | constant | dissipation | constant | dissipation |
| | (Dk) | factor (Df) | (Dk) | factor (Df) |
| Example 8 - | 3.6 | 0.0038 | 3.57 | 0.0039 |
| Laminated | | | | |
| substrate (14) | | | | |
| Comparative | 3.5 | 0.0045 | 3.53 | 0.0048 |
| Example 3- | | | | |
| laminated | | | | |
| substrate (7) | | | | |
| Example 12 - | 2.9 | 0.0029 | 2.95 | 0.0032 |
| Laminated | | | | |
| substrate (18) | | | | |
| Comparative | 3.1 | 0.0022 | 2.94 | 0.0031 |
| Example 6- | | | | |
| Laminated | | | | |
| substrate (11) | | | | |

As shown in Table 4, the primer layer preparing from the primer composition of the disclosure would not obviously affect the dielectric characteristic of the laminated substrate. As a result, the adhesion strength between the conductive layer and the dielectric layer (of the laminated substrate prepared from the primer composition of the disclosure) can be improved without deteriorating the dielectric characteristics (such as dielectric constant (Dk) and dielectric dissipation facto (Df)) of the laminated substrate.

### Examples 14-16

Primer compositions (7)-(9) were individually used to prepare Laminated substrates (20)-(22). First, the primer composition was coated on a copper foil (commercially available from Fukuda, with a trade number of T9DA) (with a thickness of about 18 μm, a surface average surface roughness (Rz) of about 0.5 μm) via a coating stick. After 150° C. for 5 minutes to cure the composition, a primer layer (with a thickness of about 6 μm) was obtained. Next, a prepreg (with a trade number of RO-4450, commercially available from Rogers Co.) was disposed on the primer layer, obtaining a laminated structure. Next, the laminated structure was subjected to a thermocompression via a vacuum thermocompressor (at a temperature of 205° C. under a pressure of 15 kg/cm² for 2 hours), obtaining a laminated substrate. Next, the laminated substrate was subjected to a peeling strength test, and the result is shown in Table 5.

TABLE 5

| | weight ratio of | peeling | dielectric |
|---|---|---|---|
| | styrene to ethylene- | strength | dissipation |
| | butadiene | (kg/cm)) | factor (Df) |
| Example 14 - | 16:84 | 0.25 | 0.0036 |
| Laminated | | | |
| substrate (20) | | | |
| Example 8 - | 30:70 | 0.75 | 0.0038 |
| Laminated | | | |
| substrate (14) | | | |
| Example 15 - | 47:53 | 0.45 | 0.0041 |
| Laminated | | | |
| substrate (21) | | | |
| Example 16 - | 80:20 | 0.5 | 0.0042 |
| Laminated | | | |
| substrate (22) | | | |

### Examples 17-19

Primer compositions (7)-(9) were individually used to prepare Laminated substrates (23)-(25). First, the primer composition was coated on a copper foil (commercially available from Fukuda, with a trade number of T9DA) (with a thickness of about 18 μm, a surface average surface roughness (Rz) of about 0.5 μm) via a coating stick. After 150° C. for 5 minutes to cure the composition, a primer layer (with a thickness of about 6 μm) was obtained. Next, a prepreg (with a trade number of R-5680 (MEGTRON7 series), commercially available from Panasonic) was disposed on the primer layer, obtaining a laminated structure. Next, the laminated structure was subjected to a thermocompression via a vacuum thermocompressor (at a temperature of 205° C. under a pressure of 15 kg/cm² for 2 hours), obtaining a laminated substrate. Next, the laminated substrate was subjected to a peeling strength test and the dielectric dissipation factor (Df) of the laminated substrate was measured, and the result is shown in Table 6.

TABLE 6

| | weight ratio of | peeling | dielectric |
|---|---|---|---|
| | styrene to ethylene- | strength | dissipation |
| | butadiene | (kg/cm)) | factor (Df) |
| Example 17 - | 16:84 | 0.4 | 0.0025 |
| Laminated | | | |
| substrate (23) | | | |
| Example 12 - | 30:70 | 1.02 | 0.0029 |
| Laminated | | | |
| substrate (18) | | | |
| Example 18 - | 47:53 | 0.45 | 0.003 |
| Laminated | | | |
| substrate (24) | | | |
| Example 19 - | 80:20 | 0.8 | 0.0031 |
| Laminated | | | |
| substrate (25) | | | |

As shown in Tables 5 and 6, when the weight ratio of styrene to ethylene-butadiene (of the vinyl-aromatic-conjugated-diene copolymer) is in the range of 20:80 to 40:60 (such as about 30:70), the adhesion strength between the dielectric layer and the conductive layer of the laminated substrate can be improved.

### Examples 20 and 21

Primer compositions (10) and (11) were individually used to prepare Laminated substrates (28) and (29). First, the primer composition was coated on a copper foil (commercially available from Fukuda, with a trade number of T9DA) (with a thickness of about 18 μm, a surface average surface roughness (Rz) of about 0.5 μm) via a coating stick. After 150° C. for 5 minutes to cure the composition, a primer layer (with a thickness of about 2.5 am) was obtained. Next, a prepreg (with a trade number of RO-4450, commercially available from Rogers Co.) was disposed on the primer layer, obtaining a laminated structure. Next, the laminated structure was subjected to a thermocompression via a vacuum thermocompressor (at a temperature of 205° C. under a pressure of 15 kg/cm² for 2 hours), obtaining a laminated substrate. Next, Laminated substrate (28) was subjected to a peeling strength test, and the result is shown in Table 7.

TABLE 7

| | SEBS | tris(2-acryloyloxy- | KBM-503 | KBM-603 | KBM-1003 | peeling |
|---|---|---|---|---|---|---|
| | (parts by | ethyl)isocyanurate | (parts by | (parts by | (parts by | strength |
| | weight) | (parts by weight) | weight) | weight) | weight) | (kg/cm) |
| Example 1 - | 77.8 | 13.9 | 8.3 | 0 | 0 | 0.48 |
| Laminated | | | | | | |
| substrate (1) | | | | | | |
| Comparative | 84.8 | 15.2 | 0 | 0 | 0 | 0.37 |
| Example 2- | | | | | | |
| Laminated | | | | | | |
| substrate (6) | | | | | | |
| Comparative | 0 | 0 | 0 | 0 | 0 | <0.1 |
| Example 3- | | | | | | |
| Laminated | | | | | | |
| substrate (7) | | | | | | |
| Example 20 - | 77.8 | 13.9 | 0 | 8.3 | 0 | 0.45 |
| Laminated | | | | | | |
| substrate (28) | | | | | | |

### Examples 22 and 23

Primer compositions (10) and (11) were individually used to prepare Laminated substrates (30) and (31). First, the primer composition was coated on a copper foil (commercially available from Fukuda, with a trade number of T9DA) (with a thickness of about 18 μm, a surface average surface roughness (Rz) of about 0.5 μm) via a coating stick. After 150° C. for 5 minutes to cure the composition, a primer layer (with a thickness of about 2.5 μm) was obtained. Next, a prepreg (with a trade number of R-5680 (MEGTRON7 series), commercially available from Panasonic) was disposed on the primer layer, obtaining a laminated structure. Next, the laminated structure was subjected to a thermocompression via a vacuum thermocompressor (at a temperature of 205° C. under a pressure of 15 kg/cm² for 2 hours), obtaining a laminated substrate. Next, Laminated substrates (30) was subjected to a peeling strength test, and the result is shown in Table 8.

TABLE 8

| | SEBS | tris(2-acrylyloxy- | KBM-503 | KBM-603 | KBM-1003 | peeling |
|---|---|---|---|---|---|---|
| | (parts by | ethyl)isocyanurate | (parts by | (parts by | (parts by | strength |
| | weight) | (parts by weight) | weight) | weight) | weight) | (kg/cm) |
| Example 5 - | 77.8 | 13.9 | 8.3 | 0 | 0 | 0.8 |
| Laminated | | | | | | |
| substrate (8) | | | | | | |
| Comparative | 84.8 | 15.2 | 0 | 0 | 0 | 0.7 |
| Example 5- | | | | | | |
| Laminated | | | | | | |
| substrate (10) | | | | | | |
| Comparative | 0 | 0 | 0 | 0 | 0 | 0.4 |
| Example 6- | | | | | | |
| Laminated | | | | | | |
| substrate (11) | | | | | | |
| Example 22 - | 77.8 | 13.9 | 0 | 8.3 | 0 | 0.8 |
| Laminated | | | | | | |
| substrate (30) | | | | | | |

As shown in Tables 7 and 8, in comparison with the composition without the silane coupling agent, the laminated substrate employing the primer layer prepared from the primer composition, which has specific constituents and amount, of the disclosure indeed exhibits improved adhesion strength between the copper foil and the prepreg.

It will be clear that various modifications and variations can be made to the disclosed methods and materials. It is intended that the specification and examples be considered as exemplary only, with the true scope of the disclosure being indicated by the following claims and their equivalents.

What is claimed is:

1. A primer composition, comprising:
60 to 90 parts by weight of vinyl-aromatic-conjugated-diene copolymer;
1 to 16 parts by weight of a compound having at least three of terminal acryloyloxy groups; and,
5 to 24 parts by weight of a silane coupling agent, wherein the silane coupling agentis distinct from the compound having at least three of terminal acryloyloxy groups.

2. The primer composition as claimed in claim 1, wherein the vinyl-aromatic-conjugated-diene copolymer is a copolymer prepared by copolymerizing a vinyl-aromatic monomer with a conjugated-diene monomer, wherein the ratio of the weight of units derived from the vinyl-aromatic monomer to the weight of units derived from the conjugated-diene monomer is 16:84 to 80:20.

3. The primer composition as claimed in claim 2, wherein the conjugated-diene monomer is 1,3-butadiene, isoprene, 2,3-dimethyl-1,3-butadiene, 2-phenyl-1,3-butadiene, 1,3-pentadiene, 2-methyl-1,3-pentadiene, 1,3-hexadiene, 4,5-diethyl-1,3-octadiene, 3-butyl-1,3-octadiene, or a combination thereof.

4. The primer composition as claimed in claim 2, wherein the vinyl-aromatic monomer comprises styrene, methylstyrene, ethylstyrene, cyclohexylstyrene, vinyl biphenyl, 1-vinyl-5-hexyl naphthalene, vinyl naphthalene, vinyl anthracene, or a combination thereof.

5. The primer composition as claimed in claim 1, wherein the vinyl-aromatic-conjugated-diene copolymer is styrene-butadiene block copolymer (SB), styrene-butadiene-styrene block copolymer (SBS), styrene-isoprene block copolymer (SI), styrene-isoprene-styrene block copolymer (SIS), styrene-ethylene-butadiene-styrene block copolymer (SEBS), styrene-ethylene-propylene-styrene block copolymer (SEPS), or styrene-ethylene-butadiene block copolymer (SEB).

6. The primer composition as claimed in claim 1, wherein the vinyl-aromatic-conjugated-diene copolymer is a vinyl-aromatic-conjugated-diene copolymer with a terminal functional group, wherein the terminal functional group is amino group, alkylamino group, imino group, alkylimino group, or pyridyl group.

7. The primer composition as claimed in claim 1, wherein the compound having at least three of terminal acryloyloxy groups is pentaerythritol triacrylate, ethoxylated trimethylolpropane triacrylate, trimethylolpropane propoxylated triacrylate, trimethylolpropane trimethacrylate, pentaerythritol tetraacrylate, ethoxylated pentaerythritol tetraacrylate, ditrimethylolpropane tetraacrylate, propoxylated pentaerythritol tetraacrylate, dipentaerythritol hexaacrylate, ethoxylated trimethylol propane tri-methacrylate, propoxylated glycerol trimethacrylate, trimethylol propane trimethacrylate, tris(2-acryloyloxyethyl)isocyanurate, or a combination thereof.

8. The primer composition as claimed in claim 1, wherein the silane coupling agent is a silane compoound having at least one reactive functional group, wherein the reactive functional group is amino group, alkylamino, vinyl group, thiol group, phenyl group, acryloyl group, acryloyloxy group, allyl group, vinylbenzyl group, epoxypropyl group, propargyl group, cyanoallyl group, or uramino group.

9. The primer composition as claimed in claim 8, wherein the silane coupling agent is cyclosiloxane having at least one reactive functional group or polyhedral oligomeric silsesquioxane having at least one reactive functional group.

10. The primer composition as claimed in claim 9, wherein the silane coupling agent is selected from a group of vinyltrichlorosilane, vinyltrimethoxysilane, vinyltriethoxysilane, 2-(3,4epoxycyclohexyl)ethyltrimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane,3-methacryloxypropyltriethoxysilane, 3-acryloxypropyltrimethoxysilane, N-2(-aminoethyl) 3-aminopropylmethyldimethoxysilane, N-2(-aminoethyl) 3-aminopropyltrimethoxysilane, N-2(aminoethyl) 3-aminopropyltriethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, N-(vinylbenzyl)-2-aminoethyl-3-aminopropyltrimethoxysilane hydrochloride, 3-ureidopropyltriethoxysilane, 3-chloropropyltrimethoxysilane, 3-mercaptopropylmethyldimethoxysilane, 3-mercaptopropyltrimethoxysilane, bis(triethoxysilylpropyl)tetrasulfide, 3-isocyanatepropyltriethoxysilane, vinyltris(2-methoxyethoxy)silane, vinylmethyldimethoxysilane, 3-mercaptopropyltriethoxysilane, 3-octanoylthio-1-propyltriethoxysilane, 3-isocyanatepropyltrimethoxysilane, 3-triethoxysilyl-N-(1,3-dimethyl-butylidene), 3-acryloxypropyltrimethoxysilane, N-(p-vinylbenzyl)-N-(trimethoxysilylpropyl)ethylenediamine hydrochloride, 3-glycidoxypropylmethyldimethoxysilane, bis[3-(triethoxysilyl)propyl]disulfide, vinyltriacetoxysilane, vinyltriisopropoxysilane, allyltrimethoxysilane, diallyldimethylsilane, 3-mercaptopropyltriethoxysilane, N-(1,3-dimethylbutylidene)-3-aminopropyltriethoxysilane, trimethyltriethenyl cyclotrisiloxane, tetramethyltetraethenyl cyclosiloxane and pentamethylpentaethenyl cyclopentasiloxane.

11. The primer composition as claimed in claim 1, further comprising:
an initiator, wherein the initiator is photo-initiator, thermal initiator, or a combination thereof.

12. A laminated substrate, comprising:
a first conductive layer having a surface;
a first primer layer disposed on the surface of the first conductive layer, wherein the first primer layer is a cured product of the primer composition as claimed in claim 1; and
a dielectric layer disposed on the first primer layer.

13. The laminated substrate as claimed in claim 12, wherein the surface of the first conductive layer has an average surface roughness (Rz) less than or equal to 2 μm.

14. The laminated substrate as claimed in claim 12, wherein the first conductive layer is copper foil.

15. The laminated substrate as claimed in claim 12, wherein the dielectric layer is epoxy resin, phenol formaldehyde resin, hydrocarbon resin, acrylic acid resin, polyamide, polyimide, polymethyl methacrylate (PMMA), polyvinylpyrrolidone (PE), polystyrene, or polyvinylidene fluoride.

16. The laminated substrate as claimed in claim 12, further comprising:
a second primer layer, disposed on the dielectric layer, wherein the second primer layer is a cured product of the primer composition as claimed in claim 1; and
a second conductive layer disposed on the second primer layer, wherein the second conductive layer has a surface, and the surface contacts the second primer layer.

17. The laminated substrate as claimed in claim 16, wherein the second conductive layer is copper foil.

18. The laminated substrate as claimed in claim 16, wherein the surface of the second conductive layer has an average surface roughness (Rz) less than or equal to 2 μm.
